(19) United States
(12) Patent Application Publication
(10) Pub. No.: US 2025/0337129 A1
(43) Pub. Date: Oct. 30, 2025

(54) SECONDARY BATTERY

(71) Applicant: SAMSUNG SDI CO., LTD., Yongin-si (KR)

(72) Inventor: Dae Kyu KIM, Yongin-si (KR)

(21) Appl. No.: 18/829,454

(22) Filed: Sep. 10, 2024

(30) Foreign Application Priority Data
Apr. 29, 2024 (KR) 10-2024-0056487

(51) Int. Cl. H01M 50/536; H01M 50/109; H01M 50/183

(52) U.S. Cl. CPC H01M 50/536; H01M 50/109; H01M 50/183

(57) ABSTRACT

A secondary battery includes an electrode assembly that is directly coupled to a case without a separate current collector to increase in capacity of the electrode assembly relative to an internal capacity of the secondary battery. The electrode assembly includes a first electrode tab protrudes that in a first direction, and a second electrode tab that protrudes in a second direction opposite to the first direction. A first case accommodates the electrode assembly and an opening is formed in the first case. A second case is formed in a cap shape, with an opening being formed in the second case that is larger than the opening of the first case. The second case is configured to cover the electrode assembly and surround an outer surface of a sidewall of the first case. The first electrode tab is electrically connected to the first case, and the second electrode tab is directly connected to the second case.

### BACKGROUND

### 1. Field

The present disclosure relates to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of some embodiments of the present disclosure provide a secondary battery that includes an electrode assembly directly coupled to a case without a separate current collector to thereby increase in capacity of the electrode assembly relative to size of the case.

These and other aspects and features of the present disclosure will be described in or will be apparent from the following description of embodiments of the present disclosure.

According to some embodiments, a secondary battery includes: an electrode assembly from which a first electrode tab protrudes in a first direction, and a second electrode tab protrudes in a second direction opposite to the first direction; a first case accommodating the electrode assembly, with an opening being formed in the case; and a second case formed in a cap shape, with an opening being formed in the second case that is larger than the opening of the first case, the second case being configured to cover the electrode assembly and surround an outer surface of a sidewall of the first case, wherein, the first electrode tab is electrically connected to the first case, and the second electrode tab is directly connected to the second case.

The first electrode tab may be directly connected to the first case by being in contact with and welded to the first case, and the second electrode tab may be in contact with and welded to the second case.

The secondary battery may further include a current collector plate positioned between the electrode assembly and the first case to electrically connect the first electrode tab of the electrode assembly to the first case.

The secondary battery may further include an insulating member positioned between the first case and the second case.

The first case may include an upper plate corresponding to an upper side of the electrode assembly and a sidewall extending downward from an edge of the upper plate, and the first electrode tab may be welded to the first case in a state of being in contact with an inner surface of the upper plate.

The upper plate may include: a protrusion positioned at a central area and welded to the first electrode tab; an edge disposed outside the protrusion and positioned closer to a part of the electrode assembly than the protrusion is to the part of the electrode assembly; and a connection part connecting the protrusion to the edge.

The second case may include: a lower plate corresponding to a lower side of the electrode assembly; a sidewall extending upward from an edge of the lower plate; and a crimping part extending from the sidewall and positioned above the upper plate of the first case.

The insulating member may include: a main body positioned between the sidewall of the first case and the sidewall of the second case; a first extension part extending inward from an upper end of the main body and positioned between the crimping part and the upper plate; and a second extension part extending inward from a lower end of the main body and disposed between the lower plate of the second case and a bottom surface of the sidewall of the first case.

The crimping part may be pressed to the first extension part disposed on the upper plate of the first case.

The first extension part may extends more towards the protrusion of the first case than the crimping part extends towards the protrusion.

The second extension part may extend more towards the electrode assembly than the sidewall of the first case extends toward the electrode assembly.

The second extension part may have a thickness equal to a thickness of the main body.

The second extension part may be pressed by the bottom surface of the sidewall of the first case.

The sidewall of the first case may include a flat bottom surface.

The sidewall of the first case may include a bottom surface that is inclined relative to a bottom surface of the second case.

An outer surface of a bottom part of the sidewall of the first case extends further downward than an inner surface part of the sidewall of the first case.

The secondary battery may further include an insulating washer positioned between an edge of the first case and the electrode assembly.

The secondary battery may further include a sealing tape surrounding a side surface of the electrode assembly.

the second extension part of the insulating member is thicker than the main body of the insulating member.

The first electrode tab may be provided in a central area of the electrode assembly and may not be provided on an edge area of the electrode assembly.

However, the aspects and features of the present disclosure are not limited to those described above, and other aspects and features not expressly described herein will be clearly understood by a person skilled in the art from the description of example embodiments of the present disclosure described below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view of a secondary battery according to embodiments;

FIG. 2 illustrates a cross-sectional view of the secondary battery of FIG. 1;

FIGS. 3A and 3B illustrate an enlarged view of a portion 2 of FIG. 2;

FIGS. 4A and 4B illustrate an enlarged view of a bottom surface of a sidewall of a first case of FIG. 2;

FIG. 5 illustrates a partial cross-sectional view of the secondary battery according to embodiments; and

FIG. 6 illustrates a cross-sectional view of the secondary battery according to embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

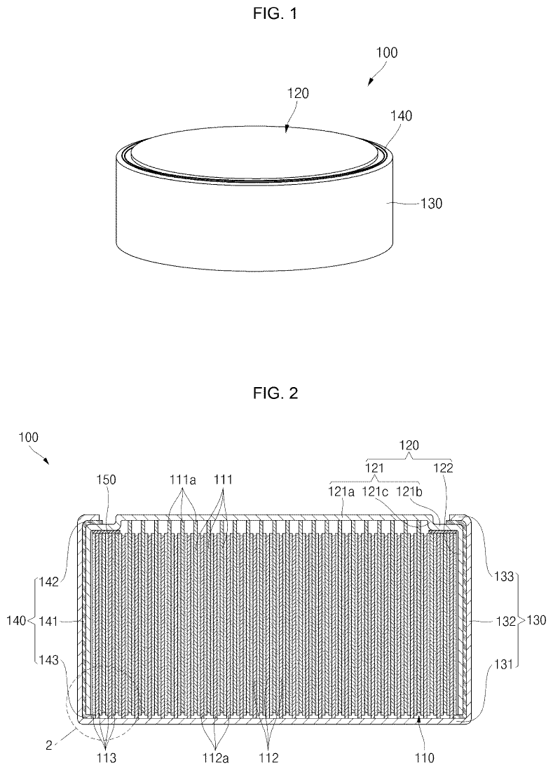

A secondary battery according to embodiments may be a coin cell or button cell as an ultra-small battery. The coin cell or the button cell may be a thin coin or button-shaped cell and may refer to a cell in which a ratio (H/D) of a height H to a diameter D is about 1 or less (see FIG. 1).

The coin cell or button cell may have a cylindrical shape, and, thus, may have a circular shape in cross-section. However, the prevent disclosure is not limited thereto, and may also include cells having an oval or polygonal horizontal cross-section. The diameter may be set as a maximum distance of an outer circumference of the case based on a horizontal direction of the cell, and the height may be set as a minimum distance between outer planes of the cell.

A coin cell or button cell are merely examples and the present disclosure is not limited to such types of cells. For example, the secondary battery according to the present disclosure may be a cylindrical or pin-type cell. However, hereinafter, the case in which the secondary battery according to embodiments described in detail will be exemplified as a coin cell or a button cell.

FIG. 1 illustrates a perspective view of a secondary battery according to embodiments, and FIG. 2 illustrates a cross-sectional view of the secondary battery of FIG. 1.

As illustrated in FIGS. 1 and 2, a secondary battery 100 may include an electrode assembly 110, and a first case 120 and a second case 130 that accommodate the electrode assembly 110. In some embodiments, the secondary battery 100 may further include an insulating member 140 disposed between the first case 120 and the second case 130.

The electrode assembly 110 may include a separator 113, and a first electrode plate 111 and a second electrode plate 112, which are disposed with the separator 113 therebetween and are wound in the form of a jelly-roll. Here, a winding axis of the electrode assembly 110 may be disposed in the same direction as a height direction of the first case 120 and the second case 130 (i.e., a vertical direction or first direction in FIGS. 1 and 2 or a second direction opposite to the first direction). In some embodiments, one end (an upper end of the electrode assembly) and the other end (a lower end of the electrode assembly) of the electrode assembly 110 may be flat and parallel to each other. Hereinafter, for convenience of explanation, one end and the other end of the electrode assembly 110 will be described as the upper end (or upper side) and the lower end (or lower side).

A first electrode plate 111 may include a first electrode current collector and a first electrode active material layer provided on at least one surface of the first electrode current collector. The first electrode plate 111 may be provided with a first electrode non-coating portion 111a, on which a first electrode active material is not applied, on an upper end thereof. This first electrode non-coating portion 111a may protrude outward from the upper end of the electrode assembly 110. In some embodiments, the first electrode non-coating portion 111a may include or be referred to as a first electrode tab. The first electrode tab 111a may be disposed on the upper end of the first electrode plate 111. The first electrode tab 111a may protrude further upward than the second electrode plate 112 and the separator 113. The first electrode tab 111a may face the first case 120. The first electrode tab 111a may be in contact with and electrically connected to the first case 120. In another example, the first electrode tab 111a may be a separate tab configuration that is coupled to and extends from the first electrode non-coating portion 111a of the first electrode plate 111.

A second electrode plate 112 may include a second electrode current collector and a second electrode active material layer provided on at least one surface of the second electrode current collector. The second electrode plate 112 may be provided with a second electrode non-coating portion 112a, on which a second electrode active material is not applied, on a lower end thereof. The second electrode non-coating portion 112a may protrude outward from the lower end of the electrode assembly 110. In some embodiments, the second electrode non-coating portion 112a may include or be referred to as a second electrode tab. The second electrode tab 112a may be disposed on the lower end of the second electrode plate 112. The second electrode tab 112a may protrude further downward than the first electrode plate 111 and the separator 113 in the electrode assembly 110. The second electrode tab 112a may face the second case 130. The second electrode tab 112a may be in contact with and electrically connected to the second case 130. In another example, the second electrode tab 112a may be a separate lead tab that is coupled to the second electrode non-coating portion 112a of the second electrode plate 112.

The first electrode plate 111 may function as a positive electrode. In some embodiments, the first substrate of the first electrode plate 111 may be provided as, for example, aluminum foil, and the first electrode active material layer may include, for example, transition metal oxide. The second electrode plate 112 may function as a negative electrode. In some embodiments, the second substrate may be provided as, for example, copper foil or nickel foil, and the second electrode active material layer may include, for example, graphite. The separator 113 may function to prevent short circuit between the first and second electrode plates 111 and 112 from occurring while allowing movement of lithium ions between the plates 111 and 112. The separator 113 may be provided as, for example, a polyethylene film, a polypropylene film, a polyethylene-polypropylene film, etc.

The first electrode tab 111a may be disposed on a top surface of the electrode assembly 110, and the second electrode tab 112a may be disposed on a bottom surface of the electrode assembly 110. In some embodiments, the first electrode tab 111a may not be provided in an edge area. In some embodiments, the electrode assembly 110 may be configured so that the outermost side of the upper end is lower in a downward direction than other areas. The electrode assembly 110 may not be provided with the first electrode tab 111a on an outer area to correspond to a shape of an upper plate of the first case 120. In some embodiments, the electrode assembly 110 may be provided with the first electrode tab 111a only at a central area thereof. Here, the central area of the electrode assembly 110 may be an area corresponding to a protrusion 121a of the first case 120, and the edge area may be an area corresponding to an edge 121b of the first case 120.

In some embodiments, a compound that may reversibly intercalate and deintercalate lithium (lithiated intercalation compound) may be used as the positive electrode active material forming the first electrode active material layer. As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiaA1-bXbO2-cDc (0.90≤a≤1.8, 0≤b≤0.5, 0≤c≤0.05); LiaMn2-bXbO4-cDc (0.90≤a≤1.8, 0≤b≤0.5, 0≤c≤0.05); LiaNi1-b-cCobXcO2-αDα (0.90≤a≤1.8, 0≤b≤0.5, 0≤c≤0.5, 0<α<2); LiaNi1-b-cMnbXcO2-αDα (0.90≤a≤1.8, 0≤b≤0.5, 0≤c≤0.5, 0<α<2); LiaNibCocL1dGeO2 (0.90≤a≤1.8, 0≤b≤0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1-bGbO2 (0.90≤a≤1.8, 0.001≤b≤0.1); LiaMn2GbO4 (0.90≤a≤1.8, 0.001≤b≤0.1); LiaMn1-gGgPO4 (0.90≤a≤1.8, 0≤g≤0.5); Li(3-f)Fe2(PO4)3 (0≤f≤2); and LiaFePO4 (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The first case 120 may face the first electrode tab 111a of the electrode assembly 110, and the second case 130 may face the second electrode tab 112a of the electrode assembly 110. In some embodiments, an insulating member 140 may be interposed between the first case 120 and the second case 130 to electrically isolate the first case 120 and the second case 130 from each other.

The first case 120 may have a cap shape with an open lower end. The first case 120 may include an upper plate 121 and a sidewall 122 extending downward from an edge of the upper plate 121. In some embodiments, the top plate 121 may have a shape corresponding to the top surface of the electrode assembly 110.

The first case 120 may include an accommodation space into which the electrode assembly 110 is accommodated. The first case 120 may have an opening in a lower end thereof, and the electrode assembly 110 may be inserted into the first case 120 through the opening at the lower end of the first case 120. Thus, the first case 120 may cover a side surface (or lateral side) and the top surface (or upper side) of the electrode assembly 110.

The upper plate 121 of the first case 120 may include the protrusion 121a disposed at a central area thereof. The upper plate 121 may further include an edge 121b disposed outside the protrusion 121a and closer to the electrode assembly 110 than the protrusion 121a. The upper plate may also include a connection part 121c that connects the protrusion 121a to the edge 121b.

The protrusion 121a may protrude more upward than the edge 121b. The first electrode tab 111a of the electrode assembly 110 may be in contact with an inner surface of the protrusion 121a. The protrusion 121a and the first electrode tab 111a may be coupled to each other by welding. For example, in the state in which the electrode assembly 110 is accommodated into the accommodation space of the first case 120, the protrusion 121a may be mechanically and electrically connected to the first electrode tab 111a of the electrode assembly 110 by welding outside the upper plate 121 of the first case 120. Because the first electrode tab 111a is disposed at the upper end of the electrode assembly 110, if the welding is performed outside the protrusion 121a of the upper plate 121 of the first case 120, the first case 120 may be welded to the electrode tab 111a. In some embodiments, the first case 120 may have the same polarity as the first electrode plate 111 of the electrode assembly 110. The first electrode tab 111a of the electrode assembly 110 may be electrically connected to the first case 120 by the welding outside of the first case 120 without a separate current collector plate.

As shown in FIG. 2, the edge 121b may be disposed lower than the protrusion 121a. That is, the edge 121b may have a height difference with respect to the protruding 121a such that the edge 121b may be closer to the electrode assembly 110 than the protrusion 121a is to the electrode assembly 110. The first electrode tab 111a may not be provided at the upper side of the electrode assembly 110 adjacent to the edge 121b.

In some embodiments, an insulating washer 150 may be further provided to electrically separate the edge 121b from the upper side of the electrode assembly 110. The insulating washer 150 may be a thin film having a planar circular ring shape corresponding to the shape of the edge 121b. The first electrode tab 111a of the electrode assembly 110 may pass through a central hole of the insulating washer 150 and be coupled to the protrusion 121a of the first case 120. The insulating washer 150 may be prevent the second electrode plate 112 and the edge 121b of the electrode assembly 110 from contacting each other. The insulating washer 150 may also prevent the negative electrode active material from expanding when the secondary battery 100 is charged/discharged and thereby improve stability by preventing contact with the edge 121b of the first case 120.

The connection part 121c may connect the protrusion 121a to the edge 121b. In some embodiments, a bent portion is provided between the connection part 121c and the protrusion 121a, and a portion between the edge 121b and the connection part 121c may also be bent. The connection part 121c may connect the protrusion 121a to the edge 121b such that a portion between the protrusion 121a and the edge 121b is inclined, but embodiments are not limited thereto.

The sidewall 122 may extend downward from an outer circumference of the edge 121b to surround the side surface of the electrode assembly 110.

The second case 130 may have a cap shape with an open upper end and may include a lower plate 131 corresponding to the shape of the bottom surface of the electrode assembly and a sidewall 132 extending upward from the edge of the lower plate 131. The second case 130 may include an accommodation space into which the electrode assembly 110 is accommodated. The second case 130 may have an opening in an upper end thereof, and the opening of the upper end may be larger than the opening of the lower end of the first case 120. The sidewall 132 of the second case 130 may surround the sidewall 122 of the first case 120. In some embodiments, the first case 120 into which the electrode assembly 110 is accommodated may be inserted into and coupled to the internal accommodation space of the second case 130.

An inner surface of the lower plate 131 of the second case 130 may be in contact with the second electrode tab 112b of the electrode assembly 110. The second case 130 may be coupled to the second electrode tab 112b of the electrode assembly 110 by welding outside of the lower plate 131. In the secondary battery 100, the electrode assembly 110 may be directly coupled to the first case 120 and the second case 130 without the separate current collector to improve the capacity of the electrode assembly 110 or the battery relative to the size of the case.

The second case 130 may be further provided with a crimping part 133 at an end of the sidewall 132. The sidewall 132 of the second case 130 may extend upward such that the sidewall extends above the sidewall 122 of the first case 120. In some embodiments, the crimping part 133 may be bent to cover the upper side of the edge 121b of the first case 120 to press the insulating member 140. Thus, the first case 120 and the second case 130 may be coupled to each other by the crimping part 133.

Each of the first and second cases 120 and 130 may be made of a conductive metal such as aluminum, an aluminum alloy, copper, a copper alloy, nickel, a nickel alloy, iron, an iron alloy, or nickel-plated iron.

The insulating member 140 may be disposed between the first case 120 and the second case 130. The insulating member 140 may include a main body 141 disposed between the sidewall 132 of the second case 130 and the sidewall 122 of the first case 120. The insulating member may also include a first extension part 142 extending from an upper end of the main body 141 toward the protrusion 121a of the first case (e.g., inward direction) and disposed between the crimping part 114 of the second case 130 and the edge 121b of the first case 120, and a second extension part bent from a lower end of the main body 141 to extend toward the electrode assembly 110 (e.g., inward direction) and disposed between the lower plate 131 of the second case 130 and a bottom surface of the sidewall 122 of the first case 120.

In some embodiments, the sidewall 122 of the first case 120 may be disposed above the second extension part 143 of the insulating member 140. The second extension part 143 may protrude further toward the electrode assembly 110 than the sidewall 122 of the first case 120. An end of the second extension part 143 may protrude further toward the electrode assembly 110 than the inner surface of the sidewall 122 of the first case 120.

The first extension part 142 of the insulating member 140 may be bent and pressed when the crimping part 133 is formed on the second case 130. The first extension part 142 may extend further toward the protrusion 121a of the first case 120 than the crimping part 133 of the second case 130 extends toward the protrusion 121a. When forming the crimping part 133 of the second case 130, the insulating member 140 may be pressed to thereby seal a gap between the first case 120 and the second case 130.

In some embodiments, when the crimping part 133 of the second case 130 presses the first extension part 142 of the insulating member 140, a lower side of the sidewall 122 of the first case 120 may also be pressed, with the lower side of the sidewall 122 then pressing the second extension part 143 of the insulating member 140 disposed below the sidewall 122 of the first case 120. Thus, the first extension part 142 and the second extension part 143 may be pressed by the crimping part 133 to improve the sealing between the first and second cases 120 and 130.

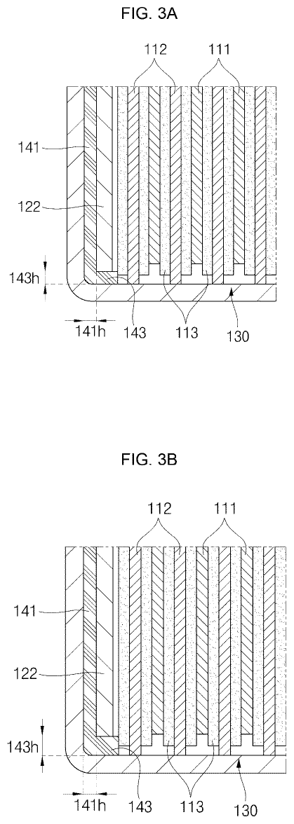

As illustrated in FIG. 3A, a thickness 143h of the second extension part 143 of the insulating member 140 may be the same as a thickness 141h of the main body 141. In other embodiments, as illustrated in FIG. 3B, the thickness 143h of the second extension part 143 of the insulating member 140 may be thicker than the thickness 141h of the main body 141. Thus, in some embodiments, the thickness 143h of the second extension part 143 of the insulating member 140 may be equal to or thicker than the thickness 141h of the main body 141. This may prevent the second extension part 143 disposed below the sidewall 122 of the first case 120 from contacting the first case 120 as a result of the pressing force when the crimping part 133 is formed.

The insulating member 140 may be made of a resin material that does not react with an electrolyte, such as polyethylene (PE), polypropylene (PP), or polyethylene terephthalate (PET). The insulating member 140 may be elastically disposed between the first case 120 and the second case 130 to improve the sealing between the first case 120 and the second case 130 and also electrically separate the first case 120 and the second case 130 from each other.

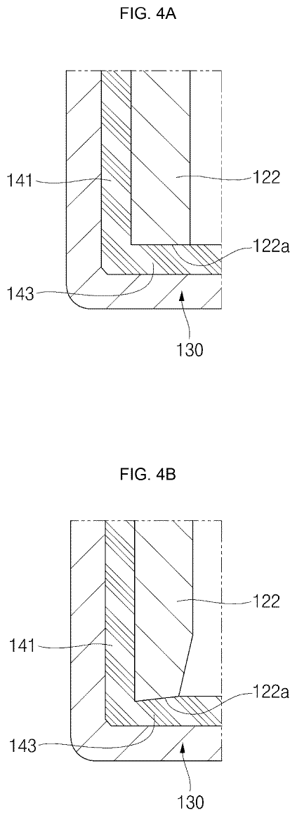

In some embodiments, a bottom surface 122a of the sidewall 122 of the first case 120 may be formed in a substantially flat plane as illustrated in FIG. 4A. In other embodiments, the bottom surface 112a may be inclined relative to a bottom surface of the second case 130 as illustrated in FIG. 4B. The bottom surface 122a of the sidewall 122 of the first case 120 may be inclined such that an outer surface of the sidewall 122 facing the main body 141 of the insulating member 140 protrudes further downward than an inner surface thereof facing the electrode assembly 110. In some embodiments, a thickness of the bottom surface 122a of the sidewall 122 may be less than a thickness of an area of the upper sidewall 122. In some embodiments, if the bottom surface 122a of the sidewall 122 of the first case 120 is inclined or has a small thickness, the pressing and sealing of the second extension part 143 of the insulating member 140 may be more effective as compared to a configuration in which the bottom surface is formed in a flat plane. If the crimping part 133 of the second case 130 presses the first extension part 142 of the insulating member 140, the second extension part 143 of the insulating member 140 may be pressed so as to press the sidewall 122 of the first case 120 downward.

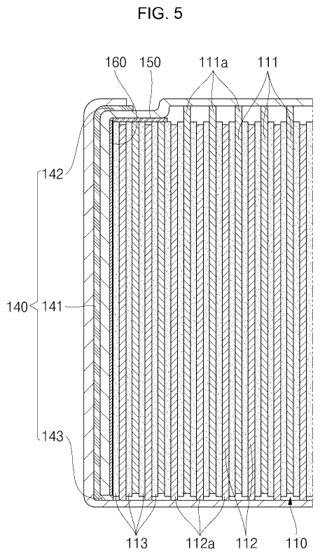

As illustrated in FIG. 5, the secondary battery 100 may further include a sealing tape 160 surrounding the outermost side of the electrode assembly 110. The sealing tape 160 may surround the side surface of the electrode assembly 110. The sealing tape 160 may electrically insulate the sidewall 122 of the first case 120 from the electrode assembly 110. The sealing tape 160 may provide electrical insulation in addition to the separator 113 disposed at the outermost side of the electrode assembly 110. The sealing tape 160 may be any tape made of an insulating material.

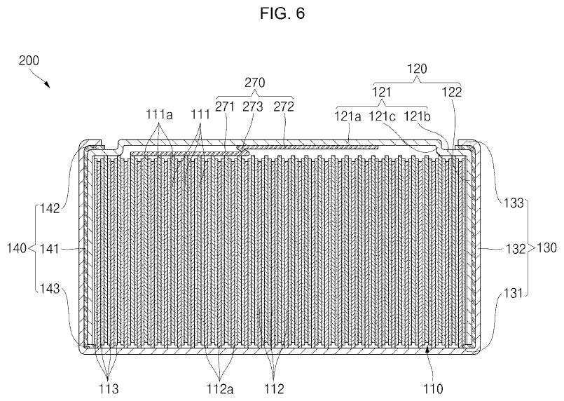

As illustrated in FIG. 6, a secondary battery 200 may include an electrode assembly 110, a first case 120 and a second case 130, which accommodate the electrode assembly 110, an insulating member 140 disposed between the first case 120 and the second case 130, and a current collector plate 270 connecting the electrode assembly 110 to the first case 120. The electrode assembly 110, the first case 120, the second case 130, and the insulating member 140 of the secondary battery 200 may be similar to those of the secondary battery 100 illustrated in FIGS. 1 and 2. However, in the embodiment illustrated in FIG. 6, the secondary battery 200 may further include the current collector plate 270. Hereinafter, a structure of the current collector plate 270 will be described.

The current collector plate 270 may be disposed between a top surface of the electrode assembly 110 and an upper plate 121 of the first case 120. In some embodiments, the current collector plate 270 may electrically connect the first electrode tab 111a of the electrode assembly 110 to the first case 120.

The current collector plate 270 may include a first connection part 271 that is in contact with and welded to the first electrode tab 111a of the electrode assembly 110 and a second connection part 272 that is in contact with and welded to an inner surface of an upper plate of the first case 120. The first connection part 271 and the second connection part 272 may be positioned parallel to each other and include a bent connection part 273 that connects the first connection part 271 and the second connection part 272. The bent connection part 273 may be bent from an end of the first connection part 271 to extend upward so as to be connected to an end of the second connection part 272, and the bent connection part 273 may be bent from the end of the second connection part 272 to extend downward. The bent connection part 273 may be connected to the first connection part 271 at an acute angle and may be connected to the second connection part 272 at an acute angle. A distance between the first connection part 271 and the second connection part 272 may be adjusted depending on a distance between the top surface of the electrode assembly 110 and the upper plate 121 of the first case 120 by the acute angle between the bent connection part 273 and the connection parts 271 and 272. Therefore, in the state in which the first connection part 271 is welded to the first electrode tab 111a of the electrode assembly 110, the second connection part 272 may easily be made to contact an inner surface of the upper plate 121 of the first case 120. The second connection part 272 of the current collector plate 270 may be electrically and mechanically connected to the first case 120 by the welding outside the upper plate 121 of the first case 120. In the secondary battery 200, the electrode assembly 110 may be directly connected to the second case 130 by the welding without a separate current collector to improve the capacity of the electrode assembly 110 of the battery relative to the size of the case.

In addition, the secondary battery 200 may further include an insulating washer 150, like the secondary battery 100 illustrated in FIG. 2, for the insulation between the electrode assembly 110 and the cases 120 and 130. Also, the secondary battery 200 may further include a sealing tape like that of the secondary battery 100 illustrated in FIG. 5.

According to embodiments of the present disclosure, the electrode assembly may be directly coupled to the case without the separate current collector to provide the secondary battery, in which the capacity of the electrode assembly is increased relative to the size of the case.

In addition, according to embodiments of the present disclosure, the insulating member may be disposed between the first case and the second case to provide a secondary battery configuration such that the insulating and sealing properties between the first case and the second case are improved.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly from which a first electrode tab protrudes in a first direction and a second electrode tab protrudes in a second direction that is opposite to the first direction;
a first case accommodating the electrode assembly, with an opening being formed in the first case; and
a second case formed in a cap shape, with an opening being formed in the second case that is larger than the opening of the first case, the second case being configured to cover the electrode assembly and surround an outer surface of a sidewall of the first case,
wherein the first electrode tab is electrically connected to the first case, and the second electrode tab is directly connected to the second case.

2. The secondary battery as claimed in claim 1, wherein the first electrode tab is directly connected to the first case by being in contact with and welded to the first case, and the second electrode tab is in contact with and welded to the second case.

3. The secondary battery as claimed in claim 1, further comprising a current collector plate positioned between the electrode assembly and the first case to electrically connect the first electrode tab of the electrode assembly to the first case.

4. The secondary battery as claimed in claim 1, further comprising an insulating member positioned between the first case and the second case.

5. The secondary battery as claimed in claim 4, wherein the first case comprises an upper plate corresponding to an upper side of the electrode assembly and a sidewall extending downward from an edge of the upper plate, and wherein the first electrode tab is welded to the first case in a state of being in contact with an inner surface of the upper plate.

6. The secondary battery as claimed in claim 5, wherein the upper plate comprises:
a protrusion positioned in a central area and welded to the first electrode tab;
an edge disposed outside the protrusion and positioned closer to a part of the electrode assembly than the protrusion is to the part of the electrode assembly; and
a connection part connecting the protrusion to the edge.

7. The secondary battery as claimed in claim 6, wherein the second case comprises:
a lower plate corresponding to a lower side of the electrode assembly;
a sidewall extending upward from an edge of the lower plate; and
a crimping part extending from the sidewall and positioned above the upper plate of the first case.

8. The secondary battery as claimed in claim 7, wherein the insulating member comprises:
a main body positioned between the sidewall of the first case and the sidewall of the second case;
a first extension part extending inward from an upper end of the main body and positioned between the crimping part of second case and the upper plate of the first case; and
a second extension part extending inward from a lower end of the main body and disposed between the lower plate of the second case and a bottom surface of the sidewall of the first case.

9. The secondary battery as claimed in claim 8, wherein the crimping part is to pressed to the first extension part disposed on the upper plate of the first case.

10. The secondary battery as claimed in claim 8, wherein the first extension part extends more towards the protrusion of the first case than the crimping part extends towards the protrusion.

11. The secondary battery as claimed in claim 8, wherein the second extension part extends more towards the electrode assembly than the sidewall of the first case extends towards the electrode assembly.

12. The secondary battery as claimed in claim 8, wherein the second extension part has a thickness equal to a thickness of the main body.

13. The secondary battery as claimed in claim 8, wherein the second extension part is pressed by the bottom surface of the sidewall of the first case.

14. The secondary battery as claimed in claim 5, wherein the sidewall of the first case includes a flat bottom surface.

15. The secondary battery as claimed in claim 5, wherein the sidewall of the first case includes a bottom surface that is inclined relative to a bottom surface of the second case.

16. The secondary battery as claimed in claim 5, wherein an outer surface of a bottom part of the sidewall of the first case extends further downward than an inner surface of part of the sidewall of the first case.

17. The secondary battery as claimed in claim 6, further comprising an insulating washer positioned between an edge of the first case and the electrode assembly.

18. The secondary battery as claimed in claim 1, further comprising a sealing tape surrounding a side surface of the electrode assembly.

19. The secondary battery as claimed in claim 8, wherein the second extension part of the insulating member is thicker than the main body of the insulating member.

20. The secondary battery as claimed in claim 1, wherein the first electrode tab is provided in a central area of the electrode assembly and is not provided on an edge area of the electrode assembly.
